(19) United States
(12) Patent Application Publication
(10) Pub. No.: US 2025/0112222 A1
(43) Pub. Date: Apr. 3, 2025

(54) SOLVENT-FREE ELECTRODE

(71) Applicant: The Swatch Group Research and Development Ltd, Marin (CH)

(72) Inventors: Nathalie MARINAKIS, Marin-Epagnier (CH); Rémy CAMILLO, Cornaux (CH)

(73) Assignee: The Swatch Group Research and Development Ltd, Marin (CH)

(21) Appl. No.: 18/794,115

(22) Filed: Aug. 5, 2024

(30) Foreign Application Priority Data
Oct. 3, 2023 (EP) 23201365.6

(51) Int. Cl. H01M 4/131; H01M 4/04; H01M 4/58; H01M 4/62; H01M 10/0565

(52) U.S. Cl. CPC H01M 4/131; H01M 4/043; H01M 4/5825; H01M 4/622; H01M 4/625; H01M 10/0565; H01M 2300/0082

(57) ABSTRACT

A solvent-free electrode (2, 3) for a lithium-ion type battery (1), which electrode includes: an active material which is a source of lithium ions, capable of receiving lithium ions and/or of releasing lithium ions into its structure; and a carbon-based material to increase the electrical conductivity of the electrode; wherein the electrode further includes a polymer with at least a maleimide group, an acrylate group or a methacrylate group, said polymer acting as a binder between the active material and the carbon-based material.

### CROSS REFERENCE TO RELATED APPLICATIONS

This application claims priority to European Patent Application No. 23201365.6 filed Oct. 3, 2023, the entire contents of which are incorporated herein by reference.

### TECHNICAL FIELD OF THE INVENTION

The present invention relates to a solvent-free electrode and to a method for manufacturing same. It further relates to a cell comprising said solvent-free electrode and optionally to a solid electrolyte.

### TECHNOLOGICAL BACKGROUND

Conventional batteries, such as lithium-ion (Li-ion) batteries, comprising a liquid electrolyte have been known for decades. However, it is known that these liquid electrolytes can adversely affect the safety of the battery, for example as a result of the generation of lithium metal dendrites which can cause short circuits in the battery. Moreover, electrolyte can leak if the battery's watertightness fails.

Solid state electrolyte (SSE) batteries have been developed in more recent years. Solid electrolytes are used to replace liquid electrolytes in alkaline metal or alkaline earth metal-ion batteries (e.g. Li-ion) and batteries with a pure alkaline metal or pure alkaline earth metal anode (e.g. Li-metal), because they offer a solution to the safety and leakage problems associated with liquid electrolytes. The drawback of solid electrolytes is that it is more difficult to create an intimate interface between the electrode and the electrolyte. This can result in a reduced battery life.

Simultaneously, and also with the aim of increasing battery life and developing safer batteries, all-solid state batteries including solvent-free electrodes have been developed. By eliminating the solvent NMP (N-methyl-2-pyrrolidone), which is most often used in the formulation of electrodes, the total energy consumed during production can be reduced by 47%. The presence of solvents requires debinding operations at high temperatures, resulting in energy losses but without leading to the total elimination of these solvents, which, like NMP, are highly toxic and harmful to health. Water could eliminate solvent recycling costs and solve toxicity problems, but the production of thick electrodes with a high energy density and excellent mechanical strength remains a challenge.

### SUMMARY OF THE INVENTION

The purpose of the present invention is to overcome the above-mentioned drawbacks by developing a solvent-free electrode with excellent mechanical strength and a high energy density, while at the same time being able to form an intimate interface with a solid electrolyte.

More specifically, the present invention consists in producing a solvent-free electrode comprising an active material, which material is a source of or receptor of lithium ions, a carbon-based material for increasing the electrical conductivity of the electrode and a polymer whose purpose is to bind the active material and the carbon-based material. Advantageously, the electrode consists solely of the active material, the carbon-based material and the polymer.

The novel electrode formulation entirely does away with the use of solvents to manufacture electrodes. This simplifies manufacture and reduces production costs.

Combined with a solid electrolyte with a composition similar to that of the polymer used as a binder in the electrode, the battery's lifespan is extended and its performance improved thanks to the intimate interface between the electrode and electrolyte materials.

More specifically, the present invention relates to a solvent-free electrode for a lithium-ion type battery, which electrode comprises:
an active material which is a source of lithium ions, capable of receiving lithium ions and/or of releasing lithium ions into its structure;
a carbon-based material to increase the electrical conductivity of the electrode;
   characterised in that it further comprises a polymer with at least a maleimide group, an acrylate group or a methacrylate group, said polymer acting as a binder between the active material and the carbon-based material.

According to alternative embodiments of the invention, the electrode has one or more of the following features:
the polymer further comprises a salt of an alkali metal and/or of an alkaline earth metal;
said at least a maleimide group, an acrylate group or a methacrylate group is an end group;
the polymer comprises at least one maleimide group and a lithium or sodium salt;
the active material comprises LiFePO₄, LiNiMnCoO₂, LiCoO₂, Li₄Ti₅O₁₂ or graphite, and the carbon-based material comprises activated carbon, carbon black and/or graphite;
it comprises a percentage by weight of active material of between 50% and 80%, preferably between 60% and 75%, a percentage by weight of carbon-based material of between 0.5% and 5%, preferably between 1% and 4%, and a percentage by weight of polymer of between 10% and 45%, preferably between 20% and 35%;
said polymer is obtained from a polymerisable composition comprising:
   a first polymer comprising a first moiety and a second moiety, the first moiety being capable of coordinating cations of an alkali metal and/or of an alkaline earth metal, the second moiety being photoactivatable and/or thermoactivatable;
   an oligomer having at least two photoactivatable and/or thermoactivatable groups;
   a second polymer comprising a third moiety, the third moiety comprising a salt of an alkali metal or of an alkaline earth metal;
   a plasticiser;
   a polymerisation initiator for initiating polymerisation between the second moiety of the first polymer and the photoactivatable and/or thermoactivatable groups of the oligomer under the effect of a temperature of between 20° C. and 150° C. or under the effect of radiation;
   one or more of the second moiety and the photoactivatable and/or thermoactivatable groups being a maleimide group, an acrylate group or a methacrylate group;
the polymerisable composition comprises between 10% and 50% by weight of the first polymer, between 1% and 20% by weight of the oligomer, between 1% and 20% by weight of the second polymer, between 20% and 60% by weight of the plasticiser, and between 0.01% and 2% by weight of the polymerisation initiator, based on the total weight of the polymerisable composition;
the polymerisable composition further comprises between 0.5% and 5% by weight of an alkali metal salt and/or of an alkaline earth metal salt, based on the total weight of the polymerisable composition;
the first moiety of the polymerisable composition comprises a polyethylene oxide moiety.

The term “photoactivatable” as used in the present disclosure includes components, molecules, groups or moieties that can be activated under the effect of radiation, such as-but not limited to-ultraviolet (UV) radiation, infrared (IR) radiation, visible light radiation, or combinations thereof.

The term “thermoactivatable” as used in the present disclosure includes components, molecules, groups or moieties that can be activated by a change in temperature. In particular, the temperature change is heating. Advantageously, the activation temperature is between 20° C. and 150° C., preferably between 25° C. and 100° C.

Activation by heat and/or radiation includes, but is not limited to, activation for oligomerisation, polymerisation or cross-linking, and/or for the initiation of oligomerisation, polymerisation or cross-linking.

An “end group” is considered to be a group that is present at one end (of the chain) of the polymer.

A “telechelic oligomer” as used in the present disclosure is considered to be an oligomer capable of undergoing subsequent polymerisation due to the presence of at least one reactive group at each of the ends (of the chain) of the oligomer.

A second aspect of the invention relates to a cell comprising, for at least one of the two electrodes, a solvent-free electrode as described above.

Advantageously, said cell further comprises a solid electrolyte produced from said polymer with at least a maleimide group, an acrylate group or a methacrylate group.

A third aspect of the invention relates to a method for manufacturing the solvent-free electrode as described above, which method comprises the steps of:
Polymerising the polymerisable composition as described above to obtain the polymer with at least a maleimide group, an acrylate group or a methacrylate group;
Mixing said polymer with a powder of the active material and a powder of the carbon-based material;
Hot pressing the resulting mixture to produce the electrode.

Advantageously, the polymer is ground to obtain a powder before the mixing step. Alternatively, after the mixing step and before the pressing step, the mixture is ground, preferably under a nitrogen atmosphere.

Advantageously, pressing is carried out at a temperature of between 90° C. and 150° C., preferably between 100° C. and 140° C., under a force of between 5 kN and 25 kN, preferably between 10 kN and 20 kN, for a time of between 1 minute and 20 minutes, preferably between 3 minutes and 10 minutes.

Advantageously, pressing is carried out between a sheet acting as a separator and a current collector.

### BRIEF DESCRIPTION OF THE FIGURES

The aims, advantages and features are shown in the figures, which illustrate, in a non-limiting manner, embodiments of the invention:

FIG. 1 shows a first moiety of a component of the polymerisable composition;

FIG. 2 shows a second moiety of a component of the polymerisable composition;

FIG. 3 shows a first component of the polymerisable composition;

FIG. 4 shows a second component of the polymerisable composition;

FIG. 5 shows a third component of the polymerisable composition;

FIG. 6 shows the components of a battery, in particular a cell battery;

FIG. 7 shows a solvent-free electrode according to the invention;

FIG. 8 shows the areal capacity of a cell comprising an electrode according to the invention as a function of the number of charge and discharge cycles;

FIG. 9 shows the voltage and current as a function of time for the various cycles on a cell comprising an electrode according to the invention.

### DETAILED DESCRIPTION OF THE INVENTION

The present invention relates to a solvent-free electrode. This electrode comprises an active material, a carbon-based material and a polymer which acts as a binder between the active material and the carbon-based material. Preferably, the electrode consists of the active material, the carbon-based material and the polymer which acts as a binder.

The active material is a source of lithium ions, capable of receiving lithium ions and/or of releasing lithium ions into its structure. Preferably, the active material is chosen from LiFePO₄, LiNiMnCoO₂, LiCoO₂, Li₄Ti₅O₁₂ and graphite. For a cathode, the active material is a source of lithium ions and is thus responsible for the electrode's capacity and able to receive lithium ions in its structure. For an anode, the active material is capable of receiving and releasing lithium ions into its structure by intercalation. For a cathode, the active material is more specifically LiFePO₄, LiNiMnCoO₂ or LiCoO₂, and for an anode, it is more specifically Li₄Ti₅O₁₂ or graphite.

The purpose of the carbon-based material is to increase the electrical conductivity of the electrode. Preferably, it comprises or consists of activated carbon, carbon black and/or graphite.

The binder polymer comprises at least a maleimide group, an acrylate group or a methacrylate group. Preferably, the maleimide group, acrylate group or methacrylate group is an end group. Preferably, there are two maleimide, acrylate or methacrylate groups with one group at each end. Preferably, there is at least one maleimide group.

Preferably, the polymer further comprises a salt of an alkali metal and/or of an alkaline earth metal. Preferably, this is a lithium salt or a sodium salt. More preferably, this is a lithium salt. Preferably, the polymer comprises at least a maleimide group and a lithium salt or a sodium salt, more preferably a lithium salt.

The electrode comprises a percentage by weight of active material of between 50% and 80%, preferably between 60% and 75%, a percentage by weight of carbon-based material of between 0.5% and 5%, preferably between 1% and 4%, and a percentage by weight of polymer of between 10% and 45%, preferably between 20% and 35%.

Said polymer is obtained from a polymerisable composition comprising:
a first polymer comprising a first moiety and a second moiety, the first moiety being capable of coordinating cations of an alkali metal and/or of an alkaline earth metal, the second moiety being photoactivatable and/or thermoactivatable;
an oligomer having at least two photoactivatable and/or thermoactivatable groups;
a second polymer comprising a third moiety, the third moiety comprising a salt of an alkali metal or of an alkaline earth metal;
a plasticiser;
a polymerisation initiator for initiating polymerisation between the second moiety of the first polymer and the photoactivatable and/or thermoactivatable groups of the oligomer under the effect of a temperature of between 20° C. and 150° C. or under the effect of radiation;
one or more of the second moiety and the photoactivatable and/or thermoactivatable groups being a maleimide group, an acrylate group or a methacrylate group.

The first moiety of the first polymer of the polymerisable

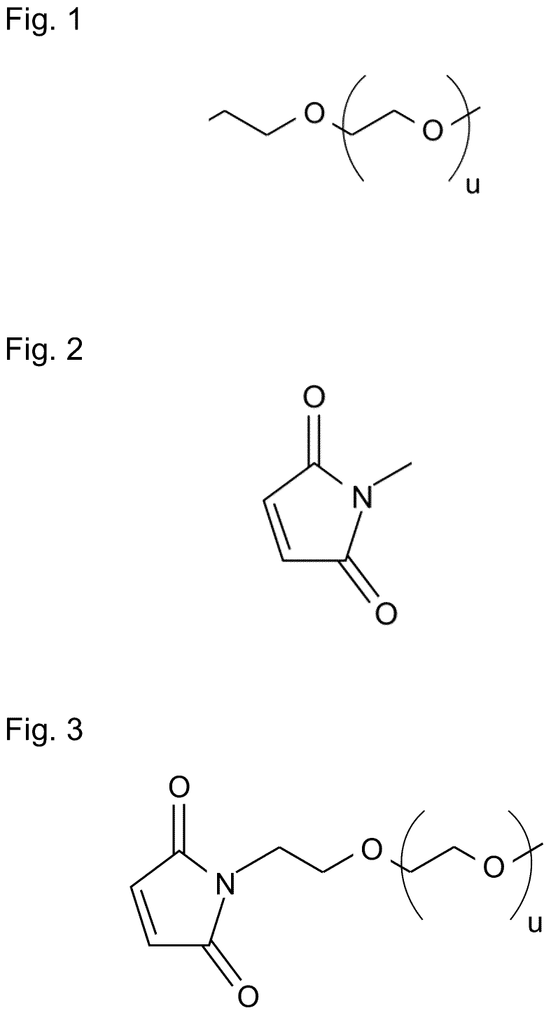

composition according to the invention is capable of coordinating cations of an alkali metal and/or of an alkaline earth metal, advantageously the cations of the alkali metal and/or of the alkaline earth metal in the electrode according to the invention. In other words, the first moiety is advantageously chosen so as to ensure ionic conductivity within the electrode. Non-limiting examples of the first moiety are a polyethylene oxide (PEO) moiety as shown in FIG. 1, and a polyethylene glycol (PEG) moiety. Advantageously, in FIG. 1, u indicates the number of repeats and is chosen between 20 and 80, preferably between 30 and 70, more preferably between 40 and 60, for example between 50 and 55.

The second moiety of the first polymer of the polymerisable composition according to the invention is a moiety provided to allow polymerisation of the polymerisable composition. The second moiety is thus photoactivatable and/or thermoactivatable. Non-limiting examples are a maleimide moiety, as shown in FIG. 2, an acrylate moiety and a methacrylate moiety.

Advantageously, the first polymer has a molar mass of between 1000 g/mol and 5000 g/mol, preferably between 1500 g/mol and 4000 g/mol, such as between 2000 g/mol and 3000 g/mol, more preferably between 2250 g/mol and 2750 g/mol, for example between 2350 g/mol and 2600 g/mol.

Advantageously, the first polymer contains between 0.1 and 0.7mEq (milliequivalent) of the second moiety per gram of first polymer, preferably between 0.2 and 0.6 mEq, more preferably between 0.3 and 0.5 mEq, for example between 0.35 and 0.45 mEq, or 0.4 mEq.

Particular examples of the first polymer are α-methoxy ω-maleimide polyethylene oxide, as shown in FIG. 3, polyethylene glycol methacrylate (PEGMA), and α-methoxy ω-maleimide polyethylene glycol.

Advantageously, the polymerisable composition contains between 10% and 50% by weight of the first polymer, preferably between 12% and 45% by weight, for example between 15% and 40% by weight, based on the total weight of the polymerisable composition.

The polymerisable composition also contains an oligomer. The oligomer has at least two photoactivatable and/or thermoactivatable groups.

These groups can be polymerised with the second moiety of the first polymer and/or with a third moiety of a second polymer. Preferably, the groups of the oligomer can be polymerised with at least the third moiety of a second polymer. The photoactivatable and/or thermoactivatable groups can be, but are not limited to, a maleimide group, an acrylate and a methacrylate.

Advantageously, the oligomer contains between 0.1 and 0.7 mEq (milliequivalent) of photoactivatable and/or thermoactivatable groups per gram of oligomer, preferably between 0.2 and 0.9 mEq, more preferably between 0.3 and 0.8 mEq, for example between 0.4 and 0.7 mEq, or between 0.5 and 0.6 mEq.

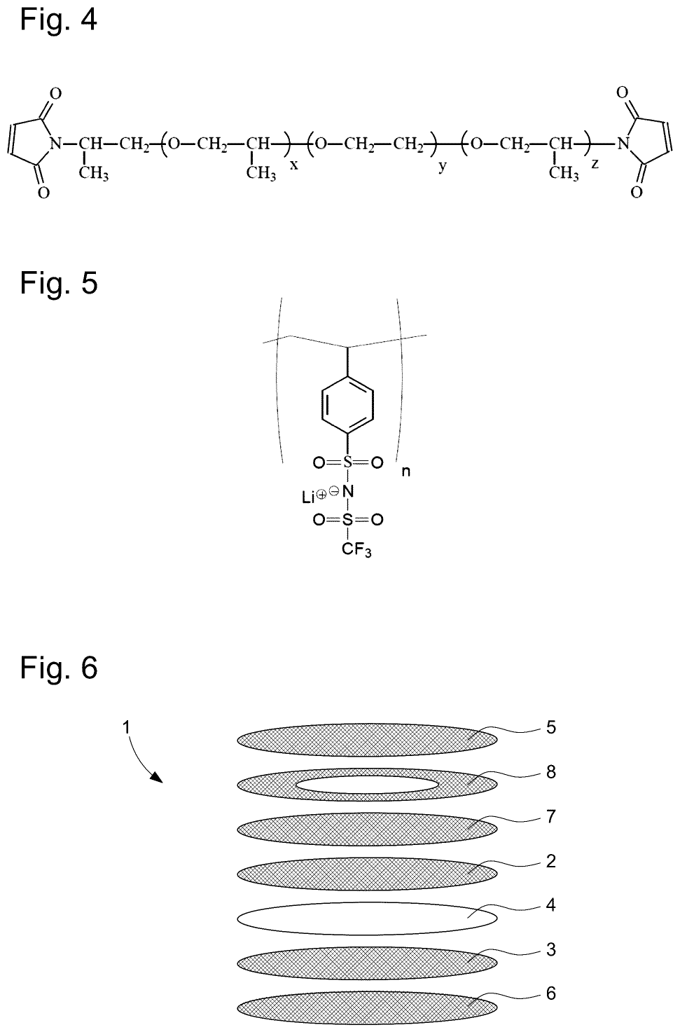

An example of the oligomer is PPG-block-PEG-block-PPG, α,ω-bis(maleimide), shown in FIG. 4, which is a polyethylene oxide-polypropylene oxide (PEO-PPO) having a maleimide group at each end of the chain. Advantageously, x+z is between 2 and 20, preferably between 5 and 15, more preferably between 6 and 12, for example between 8 and 9. Advantageously, y is between 20 and 100, preferably between 40 and 80, more preferably between 50 and 75, for example between 60 and 70, or between 62 and 67.

Another example of an oligomer is polyethylene glycol (PEG) having a methacrylate group (MA) at each end of the chain (PEG-DiMA).

Advantageously, the oligomer has a molar mass of between 250 g/mol and 10,000 g/mol, preferably between 500 g/mol and 5,000 g/mol, more preferably between 750 g/mol and 4,000 g/mol, for example between 1,000 g/mol and 3,750 g/mol, or between 2,000 g/mol and 3,600 g/mol.

Advantageously, the polymerisable composition contains between 1% and 20% by weight of the oligomer, preferably between 2% and 15% by weight, for example between 3% and 15% by weight, based on the total weight of the polymerisable composition.

Advantageously, the oligomer comprises at least one photoactivatable and/or thermoactivatable group at each end of the oligomer chain, the oligomer in this case being a telechelic oligomer. By adding a telechelic oligomer to the polymerisable composition, the polymerisation, and thus the structure of the polymer network obtained, can be better controlled. Advantageously, the polymer network is a linear polymer network. Moreover, the chains between two nodes of the polymerised composition obtained in this manner are long enough for the polymerised composition to be fairly “loose” and for the electrode to have excellent ionic conductivity.

Advantageously, the oligomer is capable of acting as a plasticiser and/or an amplifier of the ionic conductivity of the electrode.

The second polymer of the polymerisable composition contains a third moiety. Advantageously, the third moiety comprises a salt of an alkali metal and/or a salt of an alkaline earth metal. Advantageously, the alkali metal contains lithium, sodium, potassium, or combinations thereof. Preferably, the alkali metal is lithium. Advantageously, the alkaline earth metal contains magnesium, beryllium, calcium, or combinations thereof. Preferably, the alkaline earth metal is magnesium.

Advantageously, the third moiety is capable of supplying alkali metal and/or alkaline earth metal cations into the electrode. Advantageously, the alkali metal and/or alkaline earth metal cations can move along the first polymer and the oligomer in the electrode. This movement influences the ionic conductivity of the electrode. Moreover, the third moiety, which is integrated into the chain of the second polymer, also makes it possible, in the electrode, to reduce the mobility of the counter-anions of the alkali metal and/or of the alkaline earth metal, which makes it possible to increase the mobility of the alkali metal and/or of the alkaline earth metal.

FIG. 5 shows an example of the second polymer of the polymerisable composition of the invention, in which the third moiety is lithium bis(trifluoromethane)sulphimide (LiSTFSI, CAS No. 210226-98-5).

Advantageously, the polymerisable composition contains between 1% and 20% by weight of the second polymer, preferably between 2% and 15% by weight, for example between 5% and 10% by weight, based on the total weight of the polymerisable composition.

The plasticiser in the polymerisable composition advantageously allows the components of the composition to be solubilised. An example of a plasticiser includes, but is not limited to, propylene carbonate.

Advantageously, the polymerisable composition contains between 20% and 60% by weight of the plasticiser, preferably between 25% and 55% by weight, for example between 30% and 50% by weight, based on the total weight of the polymerisable composition.

The composition further comprises a polymerisation initiator. The polymerisation initiator makes it possible to initiate polymerisation between the second moiety of the first polymer, the photoactivatable and/or thermoactivatable groups of the oligomer and the third moiety of the second polymer. Initiation of polymerisation, and/or the polymerisation itself, is carried out under the effect of a temperature of between 20° C. and 200° C., preferably between 20° C. and 150° C., more preferably between 25° C. and 100° C., such as between 30° C. and 80° C., or under the effect of radiation. Advantageously, the radiation contains one or more of the following: UV radiation, IR radiation and visible light radiation (VIS).

If the polymerisation step is carried out under the effect of radiation, preferably UV radiation, it has a duration of between 5 seconds and 20 minutes, for example between 10 seconds and 15 minutes, preferably between 20 seconds and 10 minutes, more preferably between 30 seconds and 5 minutes, such as 4 minutes, 3 minutes, 2 minutes, 1 minute, or 55 seconds, 50 seconds or 45 seconds.

If polymerisation is carried out under the effect of temperature, it lasts between 1 minute and 5 hours, preferably between 5 minutes and 4 hours, for example between 10 minutes and 3 hours, between 20 minutes and 2.5 hours, or between 30 minutes and 2 hours.

Advantageously, the polymerisation initiator is radical in nature. This means, in the present disclosure, that the polymerisation initiator is capable of releasing radicals under the effect of temperature or radiation as described above. These radicals then initiate polymerisation between the first polymer, the second polymer and the oligomer of the composition.

Examples of polymerisation initiators include, but are not limited to, 2,2′-azobis(isobutyronitrile) (AIBN) and 2-hydroxy-4′-(2-hydroxyethoxy)-2-methylpropiophenone (CAS number 106797-53-9).

Advantageously, the polymerisable composition contains between 0.01% and 2% by weight of the polymerisation initiator, preferably between 0.1% and 1.5% by weight, for example between 0.25% and 1% by weight, based on the total weight of the polymerisable composition.

The polymerisable composition can also contain a salt of an alkali metal and/or a salt of an alkaline earth metal. Advantageously, the salt of an alkali metal contains, or substantially consists of, a lithium salt. Advantageously, the salt of an alkaline earth metal contains, or substantially consists of, a magnesium salt. Non-limiting examples of the salts include lithium bis(fluorosulphonyl) imide (LIFSI) and lithium bis(trifluoromethanesulphonyl) imide (LITFSI).

The inventors have surprisingly discovered that by adding an alkali metal salt and/or an alkaline earth metal salt to the polymerisable composition, the electrode has improved ionic conductivity compared to electrodes made with a polymer obtained from a composition without an added alkali metal salt and/or alkaline earth metal salt. The inventors believe that the increased conductivity is achieved through a synergy between the salt of the third moiety of the second polymer and the separate salt added to the composition.

Advantageously, if the polymerisable composition comprises a salt of an alkali metal and/or a salt of an alkaline earth metal, the composition contains between 0.5% and 5% by weight of the salt, preferably between 0.75% and 4% by weight, for example between 1% and 3% by weight, based on the total weight of the polymerisable composition.

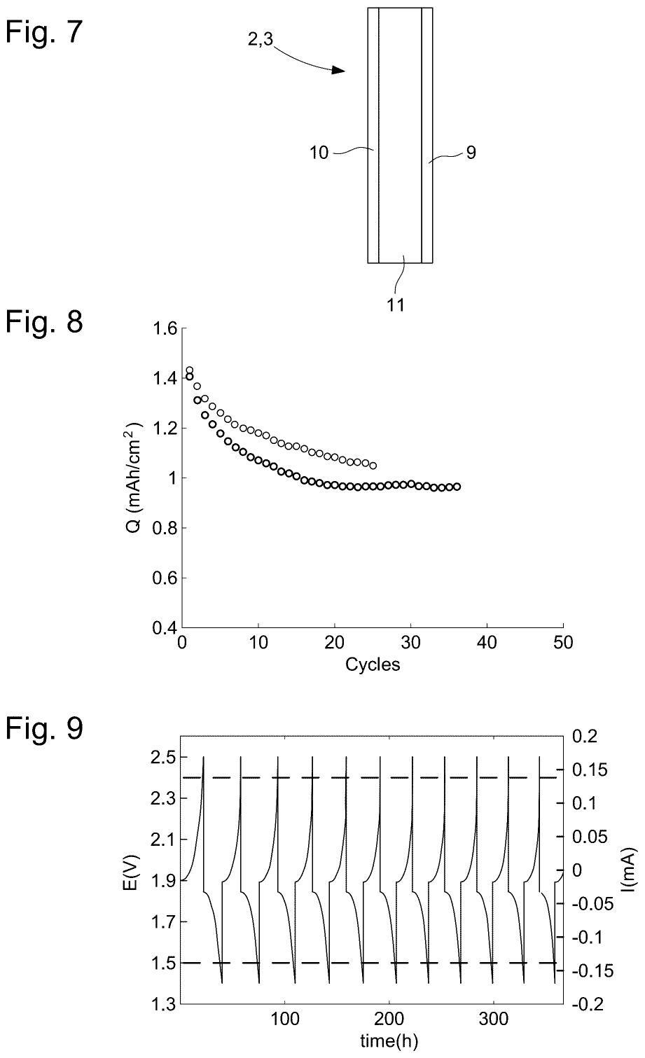

The polymer acting as a binder between the active material and the carbon-based material is obtained by polymerisation of the polymerisable composition according to the present disclosure. The electrode is manufactured by extrusion or hot pressing using this polymer obtained from the polymerisation of the polymerisable composition. The manufacturing method is described here more specifically for hot pressing (FIG. 7). The method comprises the steps of:
Polymerising the polymerisable composition described above to obtain the polymer with at least a maleimide group, an acrylate group or a methacrylate group;
Mixing the polymer with a powder of the active material and a powder of the carbon-based material;
Hot pressing the resulting mixture 11 to produce the electrode 2, 3.

Advantageously, the polymer is ground before mixing with the other powders. Alternatively, the mixture comprising the polymer and the other two powders is ground before polymerisation.

Advantageously, the method includes an additional step of freezing the polymer or mixture before the grinding step to make the polymer brittle, this step being carried out under a nitrogen atmosphere, for example.

Pressing is carried out at a temperature of between 90° C. and 150° C., preferably between 100° C. and 140° C., under a force of between 5 kN and 25 kN, preferably between 10 kN and 20 kN, for a time of between 1 minute and 20 minutes, preferably between 3 minutes and 10 minutes.

Advantageously, pressing is carried out between a sheet 9 and a current collector 10. The sheet can be an integral part of the resulting electrode or can be removed, or even fall off by itself, while retaining a functional electrode. For example, the sheet can be a cellulose sheet acting as a separator and the current collector can be made of aluminium or an aluminium alloy.

The present disclosure further relates to a cell comprising the solvent-free electrode according to the invention. FIG. 6 shows an example of a cell 1. It has a button cell configuration, known in the prior art as the CR2032 type configuration.

The cell 1 comprises an anode 2 and a cathode 3 with at least one of the two electrodes made with the formulation according to the invention. Advantageously, the cell 1 further comprises a solid polymer electrolyte 4 between the anode 2 and the cathode 3 made with the polymerisable composition described above.

Advantageously, the cell 1 further comprises a button cell cover 5, a button cell base 6, a spacer 7 and a spring 8. The spacer 7 and the spring 8 ensure good contact between the other components 2, 3, 4, 5, 6 of the cell 1.

The performance of the cell was tested for a cell comprising a cathode according to the invention with LiFePO₄ as the active material in the proportion of 70% by weight, a polymer comprising a maleimide group in the proportion of 28% by weight, and carbon black in the proportion of 2% by weight. The cathode was produced by mixing the different powders and pressing them between a cellulose sheet and an aluminium current collector under a pressure of 15 kN, at a temperature of 120° C. for 5 minutes.

The cathode was assembled within the battery comprising a commercial Li₄Ti₅O₁₂ (LTO) anode with a theoretical capacity of 1.25 mAh/cm³ and including a standard liquid electrolyte (LP30).

The life of the cell was tested by charging and discharging the cell for more than 30 cycles between 1.5 V and 2.4 V as shown in FIG. 9 for the first ten cycles. The cycling speed relative to the LTO was C/16, which corresponds to a charge of 0.140 mA. Charging was carried out by applying a constant current and discharging was carried out by applying the same current but in the negative. During each cycle, the cell was charged to a state of charge of 100% and discharged to a depth of discharge of 100%.

The results for two samples are shown in FIG. 8, which plots the areal capacity as a function of the number of cycles. FIG. 8 shows that the loss of areal capacity after 30 cycles is less than 25% compared with the areal capacity of the first cycle, with a capacity that stabilises after around 15 cycles. The battery thus has good capacity stability, which means a long service life.

1. A solvent-free electrode (2, 3) for a lithium-ion type battery, which electrode comprises:
an active material which is a source of lithium ions, capable of receiving lithium ions and/or of releasing lithium ions into its structure;
a carbon-based material to increase the electrical conductivity of the electrode (2, 3);
further comprising a polymer with at least a maleimide group, an acrylate group or a methacrylate group, said polymer acting as a binder between the active material and the carbon-based material.

2. The solvent-free electrode (2, 3) according to claim 1, wherein the polymer further comprises a salt of an alkali metal and/or of an alkaline earth metal.

3. The solvent-free electrode (2, 3) according to claim 1, wherein said at least a maleimide group, an acrylate group or a methacrylate group is an end group.

4. The solvent-free electrode (2, 3) according to claim 2, wherein the polymer comprises at least one maleimide group and a lithium or sodium salt.

5. The solvent-free electrode (2, 3) according to claim 1, wherein the active material comprises LiFePO₄, LiNiMnCoO₂, LiCoO₂, Li₄Ti₅O₁₂ or graphite, and wherein the carbon-based material comprises activated carbon, carbon black and/or graphite.

6. The solvent-free electrode (2, 3) according to claim 1, further comprising a percentage by weight of active material of between 50% and 80%, preferably between 60% and 75%, a percentage by weight of carbon-based material of between 0.5% and 5%, preferably between 1% and 4%, and a percentage by weight of polymer of between 10% and 45%, preferably between 20% and 35%.

7. The solvent-free electrode (2, 3) according to claim 1, wherein said polymer is obtained from a polymerisable composition comprising:
a first polymer comprising a first moiety and a second moiety, the first moiety being capable of coordinating cations of an alkali metal and/or of an alkaline earth metal, the second moiety being photoactivatable and/or thermoactivatable;
an oligomer having at least two photoactivatable and/or thermoactivatable groups;
a second polymer comprising a third moiety, the third moiety comprising a salt of an alkali metal or of an alkaline earth metal;
a plasticiser;
a polymerisation initiator for initiating polymerisation between the second moiety of the first polymer and the photoactivatable and/or thermoactivatable groups of the oligomer under the effect of a temperature of between 20° C. and 150° C. or under the effect of radiation;
one or more of the second moiety and the photoactivatable and/or thermoactivatable groups being a maleimide group, an acrylate group or a methacrylate group.

8. The solvent-free electrode (2, 3) according to claim 7, wherein the polymerisable composition comprises between 10% and 50% by weight of the first polymer, between 1% and 20% by weight of the oligomer, between 1% and 20% by weight of the second polymer, between 20% and 60% by weight of the plasticiser, and between 0.01% and 2% by weight of the polymerisation initiator, based on the total weight of the polymerisable composition.

9. The solvent-free electrode (2, 3) according to claim 7, wherein the polymerisable composition further comprises between 0.5% and 5% by weight of an alkali metal salt and/or of an alkaline earth metal salt, based on the total weight of the polymerisable composition.

10. The solvent-free electrode (2, 3) according to claim 7, wherein the first moiety of the polymerisable composition comprises a polyethylene oxide moiety.

11. A cell (1) comprising, for at least one of the two electrodes (2, 3), a solvent-free electrode (2, 3) according to claim 1.

12. The cell (1) according to claim 11, further comprising a solid electrolyte produced from said polymer with at least a maleimide group, an acrylate group or a methacrylate group.

13. A method for manufacturing the solvent-free electrode (2, 3) according to claim 1, said method comprising the steps of:
Polymerising the polymerisable composition to obtain the polymer with at least a maleimide group, an acrylate group or a methacrylate group;
Mixing the polymer with a powder of the active material and a powder of the carbon-based material;
Hot pressing the resulting mixture (11) to produce the electrode (2, 3).

14. The method for manufacturing the solvent-free electrode (2, 3) according to claim 13, wherein pressing is carried out at a temperature of between 90° C. and 150° C., preferably between 100° C. and 140° C., under a force of between 5 kN and 25 kN, preferably between 10 kN and 20 kN, for a time of between 1 minute and 20 minutes, preferably between 3 minutes and 10 minutes.

15. The method for manufacturing the solvent-free electrode (2, 3) according to claim 13, wherein the mixture (11) is pressed between a sheet (9) and a current collector (10).

16. The method for manufacturing the solvent-free electrode (2, 3) according to claim 13, wherein the polymer is ground before the mixing step or after the mixing step.
